(19) United States
(12) Patent Application Publication
(10) Pub. No.: US 2010/0310058 A1
(43) Pub. Date: Dec. 9, 2010

(54) MOBILE COMMUNICATION TERMINAL AND CONTROL METHOD THEREOF

(75) Inventor: Byoung Whi Kim, Daejeon (KR)

Correspondence Address: Jae Y. Park, Kile, Park, Goekjian, Reed & McManus, PLLC, 1200 New Hampshire Ave. NW, Suite 570, Washington, DC, 20036, US

(73) Assignee: ELECTRONICS AND TELECOMMUNICATIONS RESEARCH INSTIT, DAEJEON (KR)

(21) Appl. No.: 12/810,384

(22) PCT Filed: Dec. 10, 2008
(86) PCT No.: PCT/KR08/07283

§ 371 Date: Aug. 26, 2010

(30) Foreign Application Priority Data
Dec. 24, 2007 (KR) 10-2007-0136782
Oct. 13, 2008 (KR) 10-2008-0100298

(51) Int. Cl. H04M 11/00

(52) U.S. Cl. 379/88.14

(57) ABSTRACT

The present invention relates to a mobile terminal and a control method thereof. The method of controlling a mobile terminal in accordance with the present invention includes, when a specific message is received, separating text information and voice characteristic information included in the received message, converting the text information into a specific voice signal based on the separated voice characteristic information, and outputting the converted voice signal. In accordance with the present invention, text information to which voice characteristic information, indicating a sender's voice characteristic, is added is transmitted. Accordingly, text information received from a sender-side terminal can be heard as a sender's voice.

### TECHNICAL FIELD

The present invention relates to a mobile terminal and a control method thereof, and more specifically to a mobile terminal and a control method thereof, in which received text information can be heard through a sender's voice.

The present invention was supported by the IT R&D program of Ministry of Information and Communication (MIC) and Institute for Information Technology Advancement (IITA) [Project No.: 2007-S-014-01, Project Title: Metro-access integrated optical network technology].

### BACKGROUND

In order to transfer voice information, a method of converting a sender's voice into a digital signal and transmitting the digital signal has been generally used. Further, text information, such as e-mail transmitted by a sender, is generally displayed as text on the receiver side.

Of course, there is service for converting received text information into voice. In this case, however, a method of simply converting text information into predetermined voice using a text-to-speech (TTS) function embedded in a receiver-side terminal, etc. and outputting the voice has been used. Accordingly, this method has been used for a special purpose by converting text information into only predetermined voice and outputting the converted voice and cannot be used to output text information as a sender's voice.

### DISCLOSURE

### Technical Problem

Accordingly, an object of the present invention is to provide a mobile terminal and a control method thereof, which can output text information as a sender's voice.

### Technical Solution

To accomplish the above object, a method of controlling a mobile terminal according to the present invention includes the steps of receiving a user's voice signal, extracting voice characteristic information from the user's voice signal and storing the extracted voice characteristic information, and transmitting a message created by adding the voice characteristic information to specific text information when the text information is input.

Further, a method of controlling a mobile terminal according to the present invention includes the steps of receiving a message, extracting text information and voice characteristic information included in the received message, and converting the text information into a specific voice signal based on the separated voice characteristic information and outputting the converted voice signal.

Meanwhile, a mobile terminal according to the present invention includes a control unit that separates text information and a sender's voice characteristic information from a message when the message including the specific text information and the sender's voice characteristic information is received, a voice conversion unit that converts the text information into a specific voice signal based on the separated voice characteristic information, and a voice output unit that outputs the voice signal converted through the voice conversion unit.

### Advantageous Effects

In accordance with the present invention, there is an effect that text information received from a sender-side terminal can be heard as a sender's voice by adding voice characteristic information, indicating the sender's voice characteristic, to text information and transmitting the text information. Further, a voice authentication function with respect to a user can be provided on the basis of previously stored voice characteristic information, and a receiver side can perform a variety of authentication functions by employing voice characteristic information separated from received information.

### DESCRIPTION OF DRAWINGS

FIG. 1 is a system configuration to which reference is made in order to describe an operation of a mobile terminal in accordance with the present invention;

FIG. 2 is a block diagram showing the mobile terminal in accordance with an embodiment of the present invention;

FIG. 3 is a diagram showing that text information corresponding to emoticons or special symbols is defined;

FIG. 4 is a diagram showing an example in which a message including emoticons is converted into a voice signal and output; and

FIGS. 5 and 6 are flowcharts provided to describe a method of controlling the mobile terminal in accordance with an embodiment of the present invention.

### BEST MODE

Hereafter, the present invention will be described in more detail with reference to the accompanying drawings.

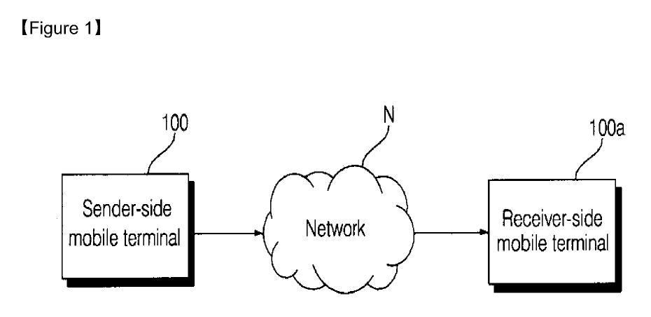

FIG. 1 is a system configuration to which reference is made in order to describe an operation of a mobile terminal in accordance with the present invention and shows the conceptual view of a mobile communication system.

Referring to FIG. 1, a mobile communication system applied to the present invention relates to a text transmission-based voice communication apparatus that is applied to a mobile terminal. When a sender-side mobile terminal 100 adds a sender's voice characteristic information to text information and transmits the text information, a receiver-side mobile terminal 100a can hear received text information as the sender's voice.

That is, when a voice signal is received from a sender, the sender-side mobile terminal 100 extracts voice characteristic information from the received voice signal and stores the extracted voice characteristic information. The sender-side mobile terminal 100 creates a message by adding voice characteristic information, which is stored whenever text information is transmitted, to the text information and transmits the created message to the receiver-side mobile terminal 100a.

Meanwhile, the receiver-side mobile terminal 100a separates the text information and the voice characteristic information, which are include in the message received from the sender-side mobile terminal 100, and converts the text information into voice based on the voice characteristic information. Accordingly, the receiver-side mobile terminal 100a converts the text information of the received message into the sender's voice and outputs the converted voice.

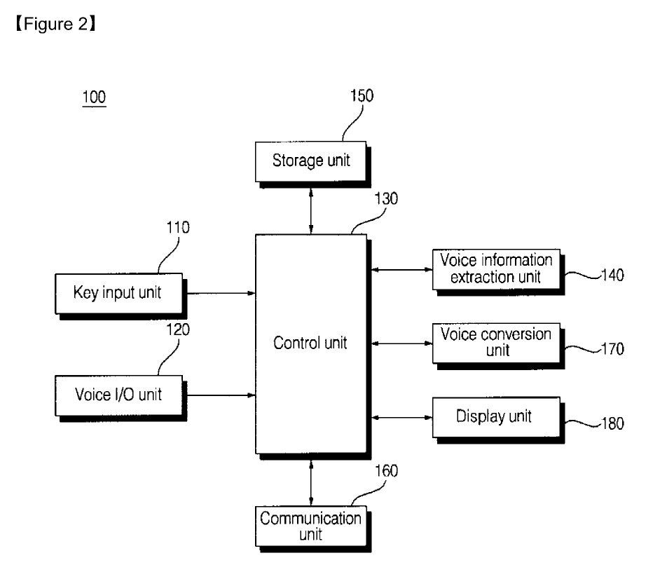

FIG. 2 is a block diagram showing a mobile terminal in accordance with an embodiment of the present invention and is a block diagram showing a configuration of the sender-side mobile terminal. The receiver-side mobile terminal basically has the same configuration as that of the sender-side mobile terminal.

First, referring to FIG. 2, the mobile terminal in accordance with the present invention includes a key input unit 110, a voice I/O unit 120, a voice information extraction unit 140, a storage unit 150, a communication unit 160, a voice conversion unit 170, a display unit 180, and a control unit 130 controlling an operation of each of the components.

To the key input unit 110 are input data and a signal to control the mobile terminal 100 through a plurality of keys. In particular, to the key input unit 110 is input text information according to manipulation of a plurality of keys. The voice I/O unit 120 is a device for receiving a user's voice and outputting a voice signal and can include a microphone, a speaker or the like. Here, the voice I/O unit 120 can be included within the mobile terminal 100, but can be an external device connected to the mobile terminal 100 through additional connecting means.

When a voice signal is received through the voice I/O unit 120, the voice information extraction unit 140 analyzes the received voice signal and extracts the voice characteristic information from the received voice signal. At this time, the extracted voice characteristic information of a user includes the quality of a tone, intonation, high and low of voice, etc. of the user.

The storage unit 150 stores voice characteristic information extracted by the voice information extraction unit 140. If a paging command with respect to stored data is issued from the control unit 130 when text information is transmitted, the control unit provides stored voice characteristic information. Further, the storage unit 150 stores data of the mobile terminal and set data according to an operation of the mobile terminal and also stores data downloaded from an external server, and so on. The communication unit 160 accesses a network N and transmits and receives signals. Here, the communication unit 160 includes a mobile communication module and transmits and receives radio signals to and from at least one of a base station, an external terminal, and a server over a mobile communication network. At this time, the radio signals can include voice call signals, video call signals or various forms of data according to transmission/reception of messages.

When a voice signal is received through the voice I/O unit 120, the control unit 130 applies the received voice signal to the voice information extraction unit 140. At this time, when specific voice characteristic information is extracted through the voice information extraction unit 140, the control unit 130 controls the extracted voice characteristic information to be stored in the storage unit 150. Further, when specific text information is received through the key input unit 110, the control unit 130 detects voice characteristic information stored in the storage unit 150 and creates a message by adding the detected voice characteristic information to text information. Here, the created message is transmitted to the receiver-side mobile terminal 100a through the communication unit 160.

The control unit 130 can set a voice authentication function based on voice characteristic information extracted by the voice information extraction unit 140. Accordingly, when a specific voice signal is received from the outside, the control unit 130 performs a user authentication operation by comparing voice characteristic information of the received voice signal and voice characteristic information, which is already recognized and stored.

Meanwhile, in the case in which the control unit 130 operates in a receiver-side mobile terminal, when a message is received from the sender-side mobile terminal 100 through the communication unit 160, the control unit 130 reads the received message, separates text information and voice characteristic information included in the message, and stores the separated text information and voice characteristic information in the storage unit 150. Further, the control unit 130 applies the separated text information and voice characteristic information to the voice conversion unit 170.

The voice conversion unit 170 converts text information into a voice signal based on voice characteristic information applied from the control unit 130. At this time, the control unit 130 controls the voice signal, which is converted by the voice conversion unit 170, to be output through the voice I/O unit 120. Here, the converted voice signal is a voice signal, which is converted based on voice characteristic information of a user, i.e., a sender who has sent a message. The converted voice signal is a signal converted to have at least one of characteristics, including the quality of a tone and a tone of the sender, and is output as the sender's voice when the voice signal is output through the voice output means 190.

Moreover, in the case in which a converted voice signal is output based on voice characteristic information separated from a received message, the control unit 130 can control text information, separated from the received message, to be output through the display unit 180. Here, the display unit 180 generally includes a LCD screen and displays state data according to an operation of the mobile terminal.

Further, the control unit 130 can perform a variety of authentication functions by employing voice characteristic information separated from a received message.

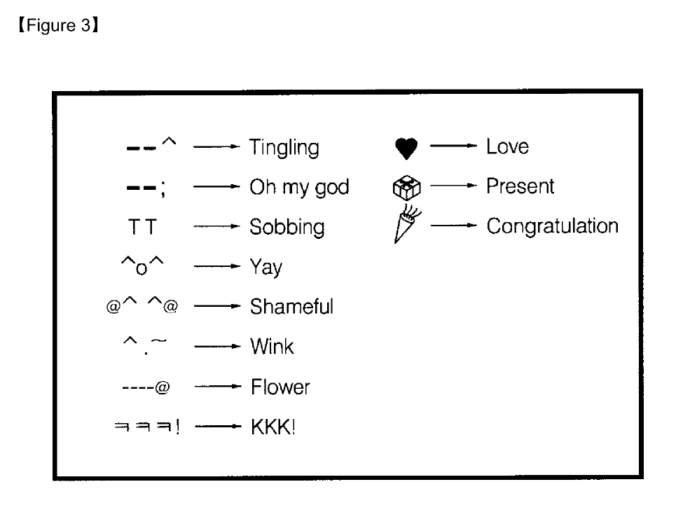

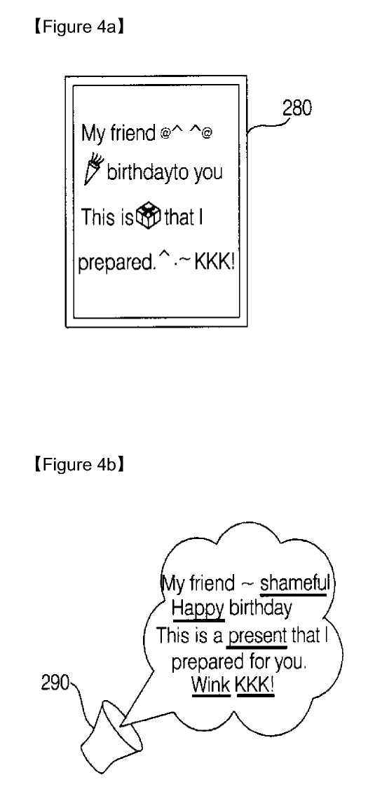

FIGS. 3 and 4 illustrate embodiments of a method of converting voice in the mobile terminal in accordance with the present invention. FIG. 3 shows the definition of text information corresponding to emoticons or special symbols conventionally used in a mobile terminal. FIG. 4 shows an example in which a message including emoticons is converted into a voice signal and output.

Referring to FIGS. 3 and 4, in the case in which a message is sent by adding voice characteristic information to input text information, the sender-side mobile terminal 100 transmits the message, including emoticons or special symbols, together with the text information.

The receiver-side mobile terminal 100a separates the text information from the message received from the sender-side mobile terminal 100. The separated text information is converted into a voice signal based on the voice characteristic information of a sender. At this time, the separated text information can be converted into a voice signal based on the sender's voice characteristic information according to the emoticons or special symbols or text information defined on emoticons or special symbols.

Accordingly, as shown in FIG. 4, if a message including emoticons is received, a voice signal converted according to text information corresponding to the respective emoticons is output through the voice output means 190.

This configuration enables text transmitted by a sender to be output as the sender's voice through the receiver-side mobile terminal 100a. The sender-side mobile terminal 100 can also define existing emoticons or special characters newly and send them together with text information. The receiver-side mobile terminal 100a can convert the symbols into sound, containing a sender's emotion, and transfer various emotional expressions of the sender.

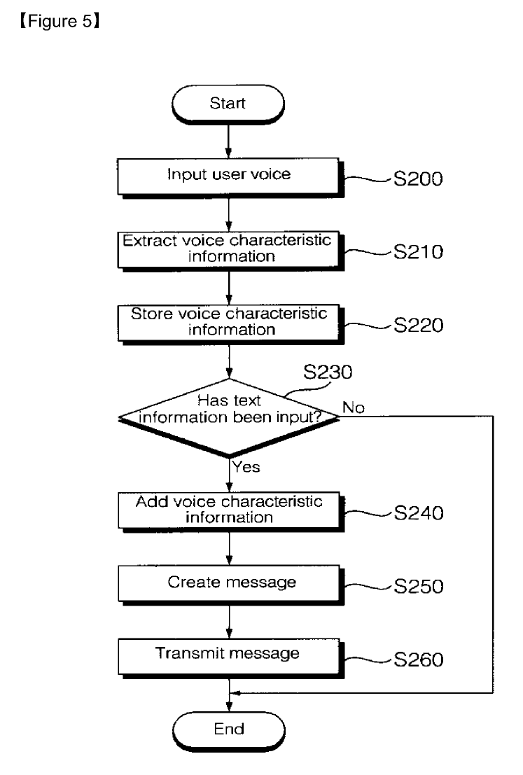

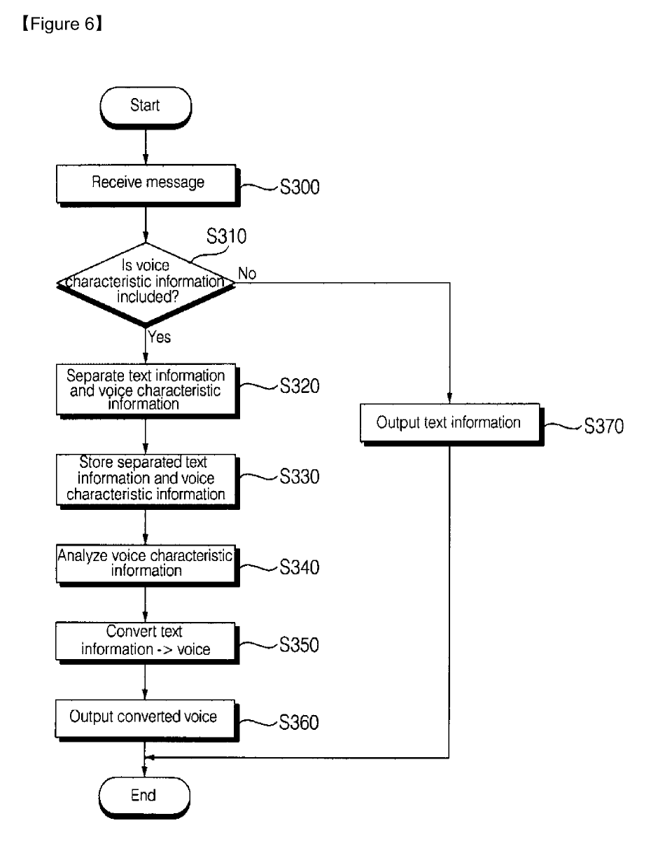

FIGS. 5 and 6 are flowcharts provided to describe a method of controlling the mobile terminal in accordance with an embodiment of the present invention. FIG. 5 shows a case in which the mobile terminal operates as a sender-side mobile terminal. FIG. 6 shows a case in which the mobile terminal operates as a receiver-side mobile terminal.

First, referring to FIG. 5, when a user's voice signal is received through the voice I/O unit 120 (S200), the voice information extraction unit 140 extracts the user's voice characteristic information from the received voice signal (S210). The control unit 130 controls the user's extracted voice characteristic information to be stored in the storage unit 150 (S220).

When specific text information is received from a user (S230), the control unit 130 detects the voice characteristic information stored in the storage unit 150 (S240) and creates a message by adding the detected voice characteristic information to the received text information (S250). At this time, the control unit 130 controls the message, which has been created by adding the voice characteristic information, to be transmitted to the receiver-side mobile terminal 100a (S260).

Here, the steps S230′ to S260 are repeatedly performed whenever text information for message transmission is received unless existing setting is changed. Meanwhile, in the case in which voice characteristic information extracted from other user's voice signal is to be registered, the steps S100 to S120 are performed again.

Meanwhile, referring to FIG. 6, when a message is received from the sender-side mobile terminal 100 (S300), the control unit 130 determines whether the received message includes voice characteristic information (S310). If, as a result of the determination, the received message includes voice characteristic information, the control unit 130 separates text information and voice characteristic information included in the received message (S320) and controls them to be stored in the storage unit 150 (S330).

At this time, the voice conversion unit 170 analyzes the voice characteristic information separated from the received message according to a control command of the control unit 130 (S340) and converts the text information, separated from the received message, into a voice signal (S350). Here, the voice characteristic information separated from the received message is a sender's voice characteristic information and includes at least one of the quality of a tone, intonation, and high and low of voice of the sender. Accordingly, the voice signal converted through the voice conversion unit 170 has at least one of characteristics, including the quality of a tone, intonation, and high and low of voice of the sender.

The voice signal converted based on the sender's voice characteristic information as described above is output through the voice output means 190 (S360).

Meanwhile, if, as a result of the determination, the message received from the sender-side mobile terminal 100 does not include voice characteristic information, the control unit 130 controls text information, included in the received message, to be output through the display means 180 (S370). Alternatively, the text information of the message received from the sender-side terminal 100 can be converted into a voice signal based on voice characteristic information already stored in the receiver-side terminal 100a other than the sender's voice characteristic information and then output according to setting.

While the preferred embodiment of the present invention has been shown and described, the present invention is not restricted by the specific embodiment. It is to be appreciated that those skilled in the art can modify the embodiment in various ways without departing from the scope and spirit of the present invention and the modified embodiments should not be construed individually from the technical spirit or prospect of the present invention.

1. A method of controlling a mobile terminal, comprising:
receiving a user's voice signal;
extracting voice characteristic information from the user's voice signal and storing the extracted voice characteristic information; and
transmitting a message created by adding the voice characteristic information to specific text information when the text information is input.

2. The method of claim 1, wherein the voice characteristic information includes at least one information of the quality of a tone, intonation, and high and low of voice of the user.

3. The method of claim 1, further comprising:
defining text information including emoticons and special symbols, and, when the emoticons and special symbols are input, creating a message by adding corresponding text information.

4. The method of claim 1, further comprising:
authenticating a user based on the result of comparing an input voice signal and the stored voice characteristic information.

5. A method of controlling a mobile terminal, comprising:
receiving a message;
extracting text information and voice characteristic information included in the received message; and
converting the text information into a specific voice signal based on the separated voice characteristic information and outputting the converted voice signal.

6. The method of claim 5, further comprising:
when outputting the converted voice signal, displaying the text information separated from the received message.

7. A mobile terminal, comprising:
a control unit configured to separate text information and a sender's voice characteristic information from a message when the message including the specific text information and the sender's voice characteristic information is received;
a voice conversion unit configured to convert the text information into a specific voice signal based on the separated voice characteristic information; and
a voice output unit configured to output the voice signal converted through the voice conversion unit.

8. The mobile terminal of claim 7, further comprising a display unit on which the text information separated from the received message is displayed when the converted voice signal is output.

9. The mobile terminal of claim 8, further comprising:
a voice I/O unit configured to receive a specific voice signal from a user; and
a voice information extraction unit configured to extract the user's voice characteristic information from the received specific voice signal.

10. The mobile terminal of claim 8, wherein the control unit controls a message, which is created by adding the user's voice characteristic information to specific text information when the specific text information is input, to be transmitted.
